(19) United States
(12) Patent Application Publication
(10) Pub. No.: US 2006/0250321 A1
(43) Pub. Date: Nov. 9, 2006

(54) Dual image display system and method thereof

(75) Inventors: Kyung Shik Park, Seoul (KR); Woong Jeong, Seoul (KR)

Correspondence Address: JONATHAN Y. KANG, ESQ.;LEE, HONG, DEGERMAN, KANG & SCHMADEKA, 14th Floor, 801 S. Figueroa Street, Los Angeles, CA, 90017, US

(73) Assignee: LG Electronics Inc.

(21) Appl. No.: 11/407,156

(22) Filed: Apr. 19, 2006

(30) Foreign Application Priority Data
May 3, 2005 (KR) 10-2005-0037276

(51) Int. Cl. G09G 5/00

(52) U.S. Cl. 345/1.3

(57) ABSTRACT

An image display system and method is provided that can display an OSD (On Screen Display) image on a mirror image without reversing the OSD by outputting an image and an OSD image and independently displaying the OSD image on the image.

### CROSS-REFERENCE TO RELATED APPLICATIONS

Pursuant to 35 U.S.C. § 119(a), this application claims the benefit of earlier filing date and right of priority to Korean Application No. 37276/2005, filed on May 3, 2005, the contents of which is hereby incorporated by reference herein in its entirety.

### BACKGROUND OF THE INVENTION

1. Field of the Invention

The present invention relates to a display system and, more particularly, to a dual display image display system and method that facilitates displaying an On Screen Display (OSD) image on a mirror image without reversing the OSD image.

2. Description of the Related Art

In general, a mobile terminal having dual LCDs displays images through first and second LCDs. FIG. 1 shows the construction of an image display system having dual LCDs in accordance with a conventional art.

As illustrated in FIG. 1, the conventional dual image display system includes a controller 11 for outputting an image, a first LCD 12 for displaying the image; and a second LCD 13 for reversing the image and displaying the reversed image (mirror image). The second LCD 13 reverses the image left and right (horizontally) through an internal image reversing unit (not shown).

For example, a photographer (who captures an image) can watch the first image (A) through the first LCD 12, while a subject (whose image is taken) can watch the mirror image (B) through the second LCD 13. The normal (non-reversed) image is displayed on the first LCD 12 on the photographer's side and the mirror image is displayed on the second LCD 13 on the subject's side such that the photographer and the subject can watch the normal image at mutually opposite sides.

However, the conventional dual image display system has a problem when an OSD (On Screen Display) image, such as a character, number, menu, symbol or state information, and the mirror image are displayed together on the second LCD 13 on the subject's side in that the OSD image is also reversed. That is, when the image is reversed, the OSD is also reversed and the reversed image (mirror image) and the reversed OSD image are displayed on the second LCD 13, thereby causing characters, numbers and symbols included in the OSD image to appear reversed.

Therefore, there is a need for a system and method that facilitates displaying an On Screen Display (OSD) image on a mirror image without reversing the OSD image. The present invention addresses this and other needs.

### SUMMARY OF THE INVENTION

Features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

The invention is directed to provide system and method that facilitates displaying an On Screen Display (OSD) image on a mirror image without reversing the OSD image. By independently displaying the OSD image on the mirror image, the OSD image may be displayed normally without being inverted.

In one aspect of the present invention, an image display method is provided. The method includes outputting a first image and an OSD (On Screen Display) image and independently displaying the OSD image on the first image.

It is contemplated that the method further includes changing the display position of the OSD image relative to the first image. It is further contemplated that the first image is a mirror image.

It is contemplated that the OSD image includes menus, numbers, symbols and/or characters. It is further contemplated that the method further includes capturing the first image with a camera.

It is contemplated that independently displaying the OSD image on the first image includes reversing the OSD image horizontally, reversing the horizontally reversed OSD image together with the first image and displaying the horizontally re-reversed OSD image and the horizontally reversed first image. It is further contemplated that independently displaying the OSD image on the first image includes generating a mirror image of the OSD image, horizontally reversing the mirror OSD image and the first image together and displaying the horizontally reversed mirror OSD image and the horizontally reversed first image.

In another aspect of the present invention, an image display method is provided. The method includes outputting a first image and a mirror image of a second image, reversing the first image and the mirror image and displaying the reversed first image and the reversed mirror image.

It is contemplated that the first image is an image of a subject. Preferably, the second image is an OSD image. It is further contemplated that the method further includes changing the display position of the reversed mirror image relative to the reversed first image.

In another aspect of the present invention, an image display method is provided. The method includes receiving a first image captured by a camera and an OSD (On Screen Display) image, reversing the OSD image, reversing the first image and the reversed OSD image together, displaying the reversed first image and the re-reversed OSD image on a first display unit and displaying the received first image and the OSD image on a second display unit.

It is contemplated that the method further includes obtaining the reversed OSD image as a mirror OSD image by reversing the OSD image and storing display position information related to the mirror OSD image in a look-up table. It is further contemplated that the method further includes changing the display position of the re-reversed mirror OSD image relative to the reversed first image based on the display position information stored in the look-up table.

In another aspect of the present invention, an image display system is provided. The system includes a controller adapted to output a first image of a subject and an OSD (On Screen Display) image, an OSD processor adapted to generate a mirror image of the OSD image and a display unit adapted to reverse the first image of the subject and the mirror OSD image horizontally and display the horizontally reversed first image of the subject and the horizontally reversed mirror OSD image. It is contemplated that the OSD processor is further adapted to change a display position of the mirror OSD image relative to the reversed first image. I

In another aspect of the present invention, an image display system is provided. The system includes a controller adapted to output an image captured by a camera and an OSD (On Screen Display) image, an OSD processor adapted to reserve the OSD image, an image reversing unit adapted to reserve the image captured by the camera and to reserve the reversed OSD image together and a first display unit adapted display the reversed image captured by the camera and the re-reversed OSD image.

It is contemplated that the system further includes a second display unit adapted to display the image captured by the camera and the OSD image from the controller. It is further contemplated that the OSD processor is further adapted to horizontally reverse the OSD image.

It is contemplated that the image reversing unit is further adapted to horizontally reverse the image captured by the camera and horizontally reverse the horizontally reversed OSD image together. It is further contemplated that the OSD processor is further adapted to change a display position of the horizontally re-reversed OSD image relative to the horizontally reversed image captured by the camera, the display position changed according to a user request. Preferably, the OSD processor is further adapted to change the display position of the horizontally re-reversed OSD image based on display position information related to the OSD image stored in a look-up table.

The foregoing and other objects, features, aspects and advantages of the present invention will become more apparent from the following detailed description of the present invention when taken in conjunction with the accompanying drawings. Additional features and advantages of the invention will be set forth in the description which follows, and in part will be apparent from the description, or may be learned by practice of the invention.

It is to be understood that both the foregoing general description and the following detailed description of the present invention are exemplary and explanatory and are intended to provide further explanation of the invention as claimed. These and other embodiments will also become readily apparent to those skilled in the art from the following detailed description of the embodiments having reference to the attached figures, the invention not being limited to any particular embodiments disclosed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. Features, elements, and aspects of the invention that are referenced by the same numerals in different figures represent the same, equivalent, or similar features, elements, or aspects in accordance with one or more embodiments.

FIG. 1 illustrates a conventional dual LCD image display system.

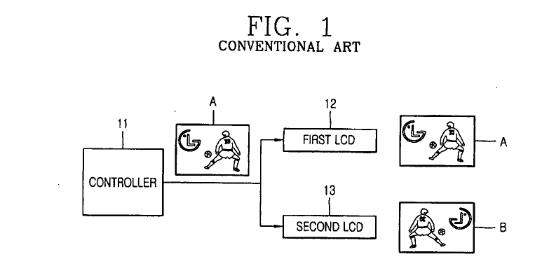

FIGS. 2A to 2C illustrate images displayed by dual LCDs of an image display system in accordance with the present invention.

FIG. 3 illustrates a dual LCD image display system in accordance with a first embodiment of the present invention.

FIG. 4 illustrates the detailed construction of an OSD processor of the image display system in accordance with the first embodiment of the present invention.

FIG. 5 illustrates a dual LCD image display system in accordance with a second embodiment of the present invention.

### DETAILED DESCRIPTION OF THE PREFERRED EMBODIMENTS

The present invention is directed to a dual display image display system and method that facilitates displaying an On Screen Display (OSD) image on a mirror image without reversing the OSD image. It is contemplated that the present invention may be utilized anytime it is desired to display an image and a mirror image simultaneously on which an OSD is displayed.

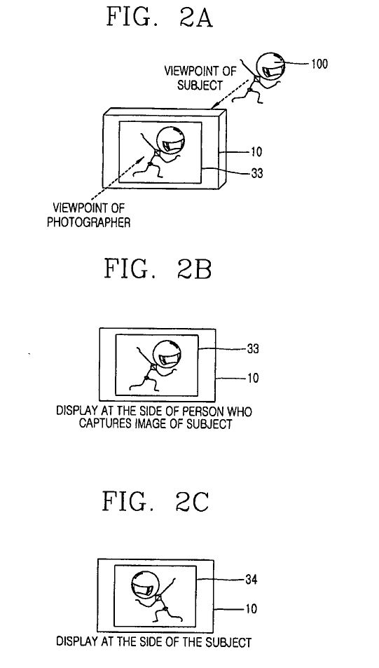

A dual image display system and method is provided that is capable of displaying an OSD (On Screen Display) image on a mirror image without inverting the OSD by outputting the image (mirror image) and the OSD image and independently displaying the OSD image on the mirror image. FIGS. 2A to 2C illustrate images displayed by dual LCDs of an image display system in accordance with the present invention. As described herein, an image capturing device for capturing an image of a subject is a mobile terminal with an image capturing function that includes dual LCDs.

As illustrated in FIGS. 2A and 2B, a photographer captures an image of a subject 100 displayed on a first LCD 33 by using a mobile terminal 10 having a camera. As illustrated in FIGS. 2A and 2B, the first LCD 33 displays the subject 100 seen by the photographer.

As illustrated in FIG. 2C, a second LCD 34 positioned at the opposite side of the first LCD 33 displays a mirror image of the image displayed by the first LCD 33 so that the subject can view a normal image. Specifically, the image displayed on the second LCD 34 is a mirror image obtained by reversing (e.g., left/right reversing) the image displayed on the first LCD 33. In this way, the mobile terminal 10 can provide a still image or video being captured to both the photographer and the subject through the dual LCDs 33 and 34 simultaneously.

When an OSD image is displayed together with the mirror image (left/right reversed image) on the second LCD 34, the OSD image is independently controlled. For example, when the OSD image is displayed together with the mirror image on the second LCD 34, the OSD image is not reversed such that it is displayed normally.

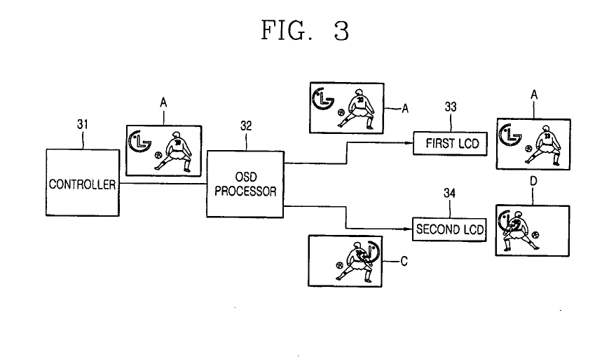

FIG. 3 illustrates an image display system in accordance with a first embodiment of the present invention. As illustrated in FIG. 3, the image display system includes a controller 31 for outputting an image (image information) of a subject captured by a camera (not shown) and an OSD image (OSD information); an OSD processor 32 for independently controlling the OSD image; a first LCD 33 for displaying the image of the subject and the OSD image; and a second LCD 34 for displaying the mirror image of the subject and the independently controlled OSD image.

The first LCD 33 or the second LCD 34 independently displays the OSD image according to the OSD processor 32. Specifically, the OSD processor 32 outputs the normal OSD image to the first LCD 33 and at the same time reverses the OSD image, for example, right and left, and then outputs the left/right reversed OSD image (mirror OSD image) to the second LCD 34. An internal image reversing unit (not shown) of the second LCD 34 reverses horizontally (left and right) the image and the mirror OSD image together and displays the horizontally reversed image and the horizontally reversed mirror OSD image (non-reversed OSD image) such that the OSD image is displayed normally on the mirror image.

The OSD processor 32 outputs a first image (A) with the OSD image to the first LCD 33 and a second image (C) with the mirror image of the OSD image to the second LCD 34. The second LCD 34 displays a third image (mirror image) (D) obtained by reversing the second image (C).

First, the controller 31 outputs an image (image information) of a subject captured by a camera (not shown) and an OSD image (OSD information) to the OSD processor 32. If a color space of the image captured by the camera is different from a color space processed by the controller 31, the controller 31 can convert the color space of the captured image into its color space and process the captured image in its color space, such as RGB (Red, Green and Blue). The controller 31 can also change (resize) resolution in order to provide a preview of the image of the subject through the first and second LCDs 33 and 34.

The OSD processor 32 outputs the image (image information) from the controller 31 and the OSD image (OSD image information) to the first LCD 33. Furthermore, the OSD processor 32 reverses only the OSD image and not the image from the controller 31 and outputs the reversed OSD image (mirror OSD image) together with the image from the controller 31 to the second LCD 34.

Specifically, the OSD processor 32 generates the mirror image of the OSD image and outputs the generated mirror OSD image to the second LCD 34. The OSD processor 32 can position the OSD image including numbers, characters or symbols at a particular position on the image from the controller 31.

The first LCD 33 displays the image and the OSD image from the OSD processor 32. As used herein, the “first LCD 33” refers to an LCD positioned at the side of the photographer who captures the image.

The second LCD 34 receives the image and the mirror OSD image and displays the mirror image and the non-reversed (normal) OSD image obtained by reversing the image and the mirror OSD image. For example, as the second LCD 34 reverses the horizontally (left-right) reversed OSD image together with the image, the image is horizontally reversed and the horizontally reversed OSD image is displayed on the second LCD 34 in a non-inverted state.

Accordingly, although the image displayed on the second LCD 34 is a mirror image, the OSD displayed on the mirror image is displayed normally (in the non-reversed state). As used herein, the “second LCD 34” refers to an LCD positioned at the side of the subject.

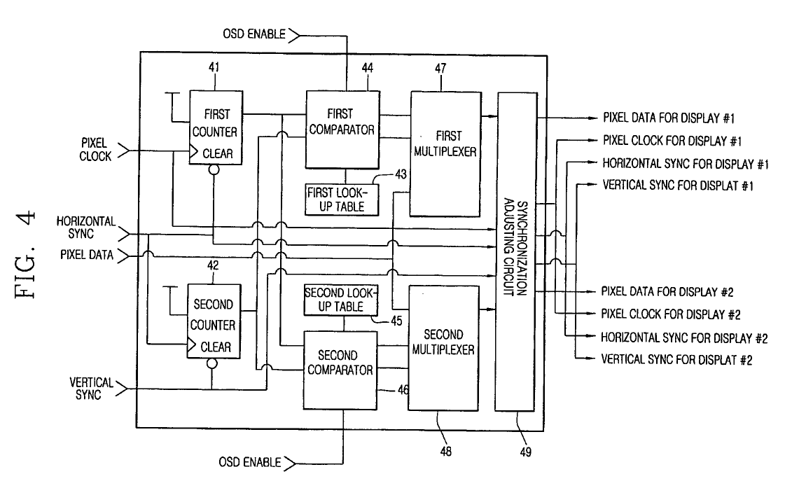

The method for reversing the OSD image and outputting the reversed OSD image can be varied. An example of the OSD processor 32 will be described in detail with reference to FIG. 4. FIG. 4 illustrates a detailed construction of an OSD processor of the image display system in accordance with the first embodiment of the present invention.

A first counter 41 of the OSD processor 32 counts a pixel clock, is cleared by a horizontal synchronization (Sync) signal and calculates a position of a pixel of a particular line. A second counter 42 counts the horizontal synchronization signal, is cleared by a vertical synchronization signal, and calculates a pixel position of a particular line.

A first OSD look-up table 43 stores position information of the OSD image displayed on the first LCD 33 and the OSD color value of the OSD image. If the OSD enable signal is high, the first comparator 44 compares the pixel position information from the first and second counters 41 and 42 to the position information of the previously stored OSD image of the first OSD look-up table 43.

If the pixel position information and the position information of the OSD image are the same, the first comparator 44 outputs a high value as a comparison value. If, however, the pixel position information and the position information of the OSD image are different, the first comparator 44 outputs a low value as a comparison value. The first comparator 44 outputs the comparison value and the corresponding OSD color value together.

A second OSD look-up table 45 stores the position information of the OSD image stored in the first OSD look-up table 43 and the OSD information whose OSD color values have been reversed horizontally (right/left) (mirror OSD image information). If the OSD enable signal is high, a second comparator 46 compares the position information of the pixel from the first and second counters 41 and 42 to the position information (position information of the horizontally (left/right) reversed OSD image) stored in the second OSD look-up table 45.

If the position information of the pixel from the first and second counters 41 and 42 are the same as the position information of the OSD image stored in the second OSD look-up table 45, the second comparator 46 outputs a high value as a comparison value. If, however, the position information of the pixel from the first and second counters 41 and 42 and the position information of the OSD image stored in the second OSD look-up table 45 are different, the second comparator 46 outputs a low value as a comparison value. The second comparator 46 outputs the comparison value and the corresponding OSD color value together.

If the comparison value of the first comparator 44 is high based on the pixel data and the OSD color value of the first comparator 44, a first multiplexer 47 outputs the OSD color value. If the comparison value of the first comparator 44 is low, the first multiplexer 47 outputs the pixel data.

If the comparison value of the second comparator 46 is high based on the pixel data and the OSD color value of the second comparator 46, a second multiplexer 48 outputs the OSD color value. If the comparison value of the second comparator 46 is low, the second multiplexer 48 outputs the pixel data.

A synchronization adjusting circuit 49 synchronizes the pixel clock, the horizontal synchronization signal and the vertical synchronization signal according to a signal delayed by the first and second comparators 44 and 45 and the first and second multiplexers 47 and 48. In this way, a stable image is output.

The OSD processor 32 can output the OSD image together with the image of the subject to the first LCD 33. The OSD processor 32 can also output the mirror image of the image of the subject and the non-reversed OSD image to the second LCD 34.

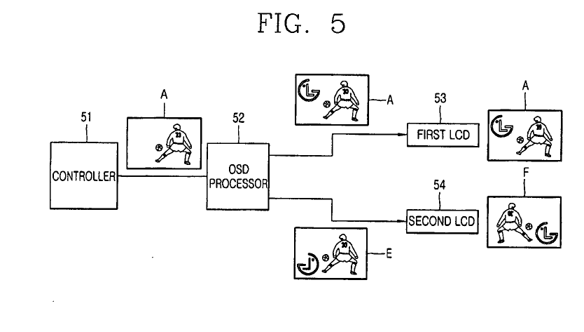

A method for positioning the OSD image including numbers, characters and symbols at a specific position of the image from the controller 31 through the OSD processor 32 will be described with reference to FIG. 5. FIG. 5 illustrates an image display system in accordance with a second embodiment of the present invention.

As illustrated in FIG. 5, the image display system includes a controller 51 for outputting an image (image information) of a subject captured by a camera (not shown) and an OSD image (OSD information); an OSD processor 52 for determining a display position of the OSD image; a first LCD 53 for displaying the image of the subject and the OSD image; and a second LCD 54 for displaying a mirror image of the subject and the OSD image whose display position has been determined. Specifically, the image display system in accordance with the second embodiment of the present invention can display the OSD image at a different position on the second LCD 54 from the position of the OSD image displayed on the first LCD 53.

For example, by storing, in the second OSD look-up table 45 of the OSD processor 52, the predetermined OSD position information for displaying the mirror OSD image on a specific position of a fourth image (E), the position of the mirror OSD image can be changed. The second LCD 54 reverses the fourth image (E) horizontally (left/right) to display a fifth image (F).

By storing a plurality of display position information of the OSD image, the OSD processor 52 can display the OSD image on a specific position according to a user request. The OSD processor 52 outputs the horizontally reversed OSD image to the second LCD 54.

As described, the image display system and method in accordance with the present invention has advantages. By independently controlling the OSD image, the OSD can be displayed normally on a mirror image. The image of the subject and the mirror OSD image of the OSD image are reversed together and the reversed subject image (mirror image) and the reversed mirror OSD image (non-reversed OSD image) are displayed to thereby display the OSD normally on the mirror image.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims. Therefore, all changes and modifications that fall within the metes and bounds of the claims, or equivalence of such metes and bounds are therefore intended to be embraced by the appended claims.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structure described herein as performing the recited function and not only structural equivalents but also equivalent structures.

What is claimed is:

1. An image display method comprising:
outputting a first image and an OSD (On Screen Display) image; and
independently displaying the OSD image on the first image.

2. The method of claim 1, further comprising changing the display position of the OSD image relative to the first image.

3. The method of claim 1, wherein the first image is a mirror image.

4. The method of claim 3, wherein the OSD image includes at least one of menus, numbers, symbols and characters.

5. The method of claim 1, further comprising capturing the first image with a camera.

6. The method of claim 1, wherein independently displaying the OSD image on the first image comprises:
reversing the OSD image horizontally;
reversing the horizontally reversed OSD image together with the first image; and
displaying the horizontally re-reversed OSD image and the horizontally reversed first image.

7. The method of claim 1, wherein independently displaying the OSD image on the first image comprises:
generating a mirror image of the OSD image;
horizontally reversing the mirror OSD image and the first image together; and
displaying the horizontally reversed mirror OSD image and the horizontally reversed first image.

8. An image display method comprising:
outputting a first image and a mirror image of a second image;
reversing the first image and the mirror image; and
displaying the reversed first image and the reversed mirror image.

9. The method of claim 8, wherein the first image is an image of a subject.

10. The method of claim 8, wherein the second image is an OSD image.

11. The method of claim 8, further comprising changing the display position of the reversed mirror image relative to the reversed first image.

12. An image display method comprising:
receiving a first image captured by a camera and an OSD (On Screen Display) image;
reversing the OSD image;
reversing the first image and the reversed OSD image together;
displaying the reversed first image and the re-reversed OSD image on a first display unit; and
displaying the received first image and the OSD image on a second display unit.

13. The method of claim 12, further comprising obtaining the reversed OSD image as a mirror OSD image by reversing the OSD image and storing display position information related to the mirror OSD image in a look-up table.

14. The method of claim 13, further comprising changing the display position of the re-reversed mirror OSD image relative to the reversed first image based on the display position information stored in the look-up table.

15. An image display system comprising:
a controller adapted to output a first image of a subject and an OSD (On Screen Display) image;
an OSD processor adapted to generate a mirror image of the OSD image; and
a display unit adapted to reverse the first image of the subject and the mirror OSD image horizontally and display the horizontally reversed first image of the subject and the horizontally reversed mirror OSD image.

16. The system of claim 15, wherein the OSD processor is further adapted to change a display position of the mirror OSD image relative to the reversed first image.

17. An image display system comprising:
a controller adapted to output an image captured by a camera and an OSD (On Screen Display) image;
an OSD processor adapted to reserve the OSD image;
an image reversing unit adapted to reserve the image captured by the camera and to reserve the reversed OSD image together; and
a first display unit adapted to display the reversed image captured by the camera and the re-reversed OSD image.

18. The system of claim 17, further comprising:
a second display unit adapted to display the image captured by the camera and the OSD image from the controller.

19. The system of claim 17, wherein the OSD processor is further adapted to horizontally reverse the OSD image.

20. The system of claim 19, wherein the image reversing unit is further adapted to horizontally reverse the image captured by the camera and horizontally reverse the horizontally reversed OSD image together.

21. The system of claim 20, wherein the OSD processor is further adapted to change a display position of the horizontally re-reversed OSD image relative to the horizontally reversed image captured by the camera, the display position changed according to a user request.

22. The system of claim 21, wherein the OSD processor is further adapted to change the display position of the horizontally re-reversed OSD image based on display position information related to the OSD image stored in a look-up table.
